(19) United States
(12) Patent Application Publication
(10) Pub. No.: US 2026/0154653 A1
(43) Pub. Date: Jun. 4, 2026

(54) DELIVERY MANAGEMENT SYSTEM

(71) Applicant: TOYOTA JIDOSHA KABUSHIKI KAISHA, Aichi-ken (JP)

(72) Inventors: Shunta SHIMIZU, Tokyo-to (JP); Ryuichi KUMAI, Yokohama-shi (JP); Yoshiaki TOYAMA, Tokyo-to (JP)

(73) Assignee: TOYOTA JIDOSHA KABUSHIKI KAISHA, Aichi-ken (JP)

(21) Appl. No.: 19/382,258

(22) Filed: Nov. 7, 2025

(30) Foreign Application Priority Data
Dec. 3, 2024 (JP) 2024-209968

(51) Int. Cl. G06Q 10/0836

(52) U.S. Cl. CPC G06Q 10/08365

(57) ABSTRACT

A delivery management system includes: a post in which a sensor for detecting information on trays inserted into insertion units are provided to the insertion units; a delivery robot to detect an object on the tray inserted into the insertion unit of the post; a terminal for transmitting receipt information indicating that a user has received the package, and package placement information; a storage to store post state information indicating the state of the insertion unit of the post; an information update unit to update the post state information in the storage based on information on the tray in the insertion unit detected by the sensor of the information update unit and an instruction unit to instruct the delivery robot to deliver the tray on which the package is placed and to collect the tray on which the package is placed, based on the post state information.

### CROSS REFERENCE TO RELATED APPLICATIONS

This application is based upon and claims the benefit of priority from Japanese patent application No. 2024-209968, filed on Dec. 3, 2024, the disclosure of which is incorporated herein in its entirety by reference.

### BACKGROUND

The present disclosure relates to a delivery management system.

A delivery management system is known that includes a delivery box in which a camera for photographing the inside of a locker is installed, and an unoccupied space inside the locker is detected from an image captured by the camera and the captured image is transmitted to the delivery management server (see, for example, Patent Literature 1).
[Patent Literature 1] Japanese Unexamined Patent Application Publication No. 2019-142600

### SUMMARY

However, in the above-mentioned delivery management system, since it is necessary to install a camera in each delivery box, shipping cost may increase.

The present disclosure has been made in order to solve such problem, and a main object of the present disclosure is to provide a delivery management system adapted to reduce shipping costs.

According to an aspect of the present disclosure for achieving the above object, a delivery management system includes:
a post unit in which a package is placed on a tray to which the package is associated in advance, the package and the tray being insertion-arrangeable in respective insertion units of the post unit, and the respective insertion units are provided with a sensor for detecting information on the tray inserted into the respective insertion units;
a delivery robot configured to deliver the tray on which the package is placed to an insertion unit of the post unit or collect the tray on which the package is placed from the insertion unit and detect an object on the tray inserted into the insertion unit of the post;
a terminal for transmitting receipt information indicating that a user has received the package placed on the tray located in the insertion unit of the post unit, and placement information indicating that the user has placed the package on the tray located in the insertion unit of the post unit;
a storage unit configured to store post state information indicating the state of the insertion unit of the post unit;
an information update unit configured to update the post state information in the storage unit based on information on the tray in the insertion unit detected by the sensor of the information update unit, information on the object placed on the tray detected by the sensor of the delivery robot, and the receipt information and the placement information transmitted from the terminal; and
an instruction unit configured to instruct the delivery robot to deliver the tray on which the package is placed and to collect the tray on which the package is placed, based on the post state information updated by the information update unit.

In this aspect,
the information update unit may be configured to update, in response to the receipt information transmitted from the terminal, the indication of the post state information to a normal state indicating that the insertion unit corresponding to the receipt information of the post unit is in a normal state, and
in the case where it is determined by the information update unit that there is a package on the tray in the insertion unit based on the information on the object placed on the tray detected by the sensor of the delivery robot, the detection being performed when the delivery robot has moved to the insertion unit of the post unit, the information update unit may update the post state information by changing the indication of the state of the insertion unit from the normal state to an abnormal state, indicating that the state of the insertion unit is in an abnormal state.

In this aspect,
the information update unit may be configured to update, in response to the placement information transmitted from the terminal, the post state information as normal-state information indicating that the state of the insertion unit corresponding to the placement information of the post unit is in a normal state, and
in the case where it is determined by the information update unit that there is no predetermined package on the tray in the insertion unit based on the information on the object placed on the tray detected by the sensor of the delivery robot, the detection being performed when the delivery robot has moved to the insertion unit of the post unit, the post state information may be updated by changing the indication of the state of insertion unit from the normal state to the abnormal state, indicating that that state of the insertion unit is abnormal.

In this aspect,
when the delivery robot delivers the tray on which the package is placed to the insertion unit of the post unit or when the delivery robot collects the tray on which the package is placed from the insertion unit, the sensor of the delivery robot may detect an object in another insertion unit of the post unit, and
the information update unit may update the post state information in the storage unit based on the information on the object placed on the tray detected by the sensor.

In this aspect,
the sensor of the delivery robot may detect, when the delivery robot delivers the tray on which the package is placed to the insertion unit of the post unit or collects the tray on which the package is placed from the insertion unit, an object in an insertion unit of another post unit installed on a traveling route to the post unit, and
the information update unit may update the post state information in the storage unit based on the information on the object placed on the tray detected by the sensor of the delivery robot.

In this aspect,
a plurality of the delivery robots may perform delivery and collection with respect to the respective insertion units of the same post unit, and the detection sensors of the respective delivery robots may respectively detect an object in the respective insertion units of the same post unit, and
the information update unit may compare the information on the objects placed on the trays detected by the respective sensors and update the post state information in the storage unit.

In this aspect,
in the package, a reception deadline by which the user receives the package may be set in advance, and
after delivering the package to the insertion unit of the post unit, the delivery robot may move to the post unit within a predetermined time after the reception deadline and the delivery robot may detect an object in the insertion unit of the post unit.

According to the present disclosure, it is possible to provide a delivery management system adapted to reduce shipping cost.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram showing a schematic configuration of a delivery management system according to this embodiment;

FIG. 2 is a diagram showing a configuration of a post unit, a delivery robot, and a terminal; and

FIG. 3 is a block diagram showing a system configuration of a server apparatus according to this embodiment.

### DESCRIPTION OF EMBODIMENTS

### First Embodiment

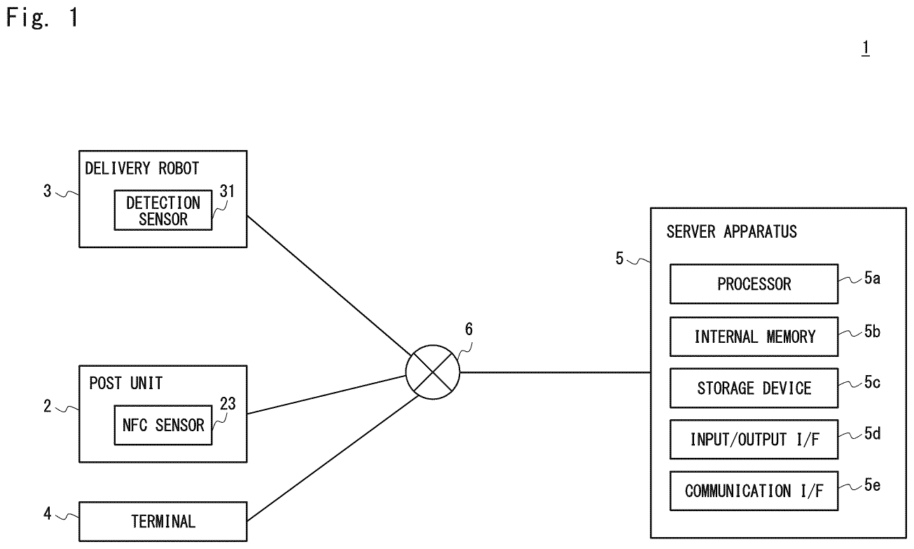

The present embodiment will be described below with reference to the drawings. FIG. 1 is a schematic diagram showing a schematic configuration of a delivery management system according to this embodiment.

For example, a user places a package to be delivered in a post unit 2 installed at a predetermined location. A delivery robot 3 takes out the package B placed in the post unit 2 and delivers it to the post unit 2 installed at the receiver-side. Alternatively, the delivery robot 3 receives (i.e., picks-up) the package addressed to the user from the post unit 2 installed at the sender-side and delivers (i.e., drops-off) the package to the post unit 2 installed at a predetermined location. The user receives (i.e., picks-up) the package from the post unit 2 installed at the predetermined location. A delivery management system 1 according to this embodiment manages the delivery by the delivery robot 3 as described above.

The delivery management system 1 according to this embodiment includes the post unit 2 to which the package or the like is delivered, the delivery robot 3 that performs delivery of the package or the like, a terminal 4 owned by the user, and a server apparatus 5.

The post unit 2, the delivery robot 3, the terminal 4, and the server apparatus 5 are mutually connected via a network 6. Here, the network 6 may be a wired or wireless communication line, for example, the Internet.

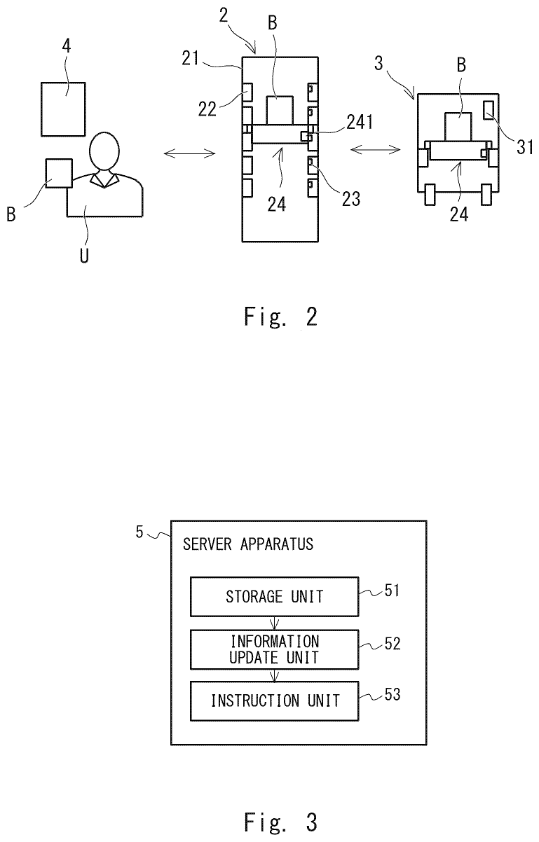

The post unit 2 is installed, for example, in the vicinity of the residence of the receiver of a package or the residence of the sender of a package. The post unit 2 includes, for example, a frame 21 and an insertion unit 22, as shown in FIG. 2. The frame 21 has, for example, a substantially rectangular shape when viewed from the front side thereof, and the front and rear surfaces of the frame 21 are open.

On the inner surface of the frame 21, a plurality of pairs of the insertion units 22 are arranged at intervals in the vertical direction of the frame 21. Each insertion unit 22 includes, for example, a pair of rails. The insertion unit 22 extends in the longitudinal direction of the frame 21, and supports a tray 24 by having the brim of the tray 24 placed on the frame 21. The plurality of the insertion units 22 have identification information including positional information on the height of the respective insertion units 22 attached thereto for each insertion unit 22.

As shown in FIG. 2, for example, the basic form of the tray 24 is a flat plate shape on which a package B can be placed, and the brim projects to the sides of the tray 24. On the side of the tray 24, a tag 241 in which identification information assigned to each tray 24 is stored is provided.

The tag 241 may be an NFC tag 241 capable of reading identification information by an NFC (Near Field Communication) sensor 23. The tray 24 is repeatedly used to deliver a package B, for example, and is delivered together with a package B. A package B is placed on a tray 24 to which the package B is associated in advance.

The NFC sensor 23 is fixed to the frame 21 for each insertion unit 22, for example, as shown in FIG. 2. The tray 24 is insertion-arranged into each insertion unit 22. The NFC sensor 23 reads the identification information of the tray 24 from the tag 241 of the tray 24 when the tray 24 is supported by the insertion unit 22.

When the tray 24 is inserted into the insertion unit 22, the NFC sensor 23 transmits the identification information of the tray 24 and the identification information of the insertion unit 22 read from the tag 241 of the tray 24 to the server apparatus 5.

As shown in FIG. 2, for example, the delivery robot 3 is configured as an autonomous mobile robot capable of traveling to an arbitrary location while holding the tray 24 on which the package B is placed.

The delivery robot 3 delivers the package B to the post unit 2 by inserting the tray 24 on which the package B is placed into the insertion unit 22 of the post unit 2. Alternatively, the delivery robot 3 collects the tray 24 on which the package B is placed by taking it out from the insertion unit 22 of the post unit 2 and delivers it to a predetermined place.

The delivery robot 3 includes a detection sensor 31 for detecting an object on the tray 24 inserted into the insertion unit 22 of the post unit 2. The detection sensor 31 is, for example, a camera. The camera can detect an object on the tray 24 by photographing the object on the tray 24 inserted into the insertion unit 22. The delivery robot 3 transmits information on the object placed on the tray 24 detected by the detection sensor 31 to the server apparatus 5.

The terminal 4 is a portable terminal such as a smartphone owned by the user U, a tablet terminal, or the like. In the case where the user U receives the package B placed on the tray 24 located in the insertion unit 22 of the post unit 2, the user U performs a predetermined operation on the terminal 4. In response to the predetermined operation, the terminal 4 transmits a receipt information indicating that the user U has received the package B placed on the tray 24 to the server apparatus 5. The receipt information includes identification information of the tray 24.

In the case where the user U places the package B on the tray 24 located in the insertion unit 22 of the post unit 2, the user U performs a predetermined operation on the terminal 4. In response to the predetermined operation, the terminal 4 transmits placement information indicating that the user U has placed the package B on the tray 24 to the server apparatus 5. The placement information includes identification information of the tray 24.

The server apparatus 5 has a conventional computer hardware configuration including, for example, a processor 5a such as a CPU (Central Processing Unit) or a GPU (Graphics Processing Unit), an internal memory 5b such as a RAM (Random Access Memory) or a ROM (Read Only Memory), an storage device 5c such as an HDD (Hard Disk Drive) or an SSD (Solid State Drive), an input/output I/F5d for connecting peripheral devices such as displays, and a communication I/F5e for communicating with external devices.

FIG. 3 is a block diagram showing a system configuration of the server apparatus according to this embodiment. The server apparatus 5 according to this embodiment includes a storage unit 51, an information update unit 52, and an instruction unit 53.

The storage unit 51 stores information on the state of a post (hereinafter referred to as post state information) indicating the state of respective insertion units 22 of the post unit 2. The state of the insertion unit 22 includes information indicating the state of the insertion unit 22, such as information on whether or not the tray 24 is inserted into the insertion unit 22, the identification information of the tray 24 inserted into the insertion unit 22, and information on whether or not the package B is placed on the tray 24 inserted into the insertion unit 22. The storage unit 51 comprises the above-described storage device and the like.

The information update unit 52 updates the post state information in the storage unit 51. The information update unit 52 updates the post state information stored in the storage unit 51 based on the information on the tray 24 of the insertion unit 22 detected by the NFC sensor 23 of the post unit 2, the information on the object detected by the detection sensor 31 of the delivery robot 3, and the receipt information and the placement information transmitted from the terminal 4.

The instruction unit 53 gives an instruction to the delivery robot 3 based on the post state information stored in the storage unit 51. The instruction unit 53 gives an instruction to the delivery robot 3 based on the post state information updated by the information update unit 52, such as to deliver the tray 24 on which the package B is placed to the post unit 2, collect the tray 24 on which the package B is placed from the post unit 2, and collect only the tray 24 from the post unit 2.

Next, a specific example of the above-described post state information update method will be described.

In response to the receipt information transmitted from the terminal 4, the information update unit 52 updates the post state information as the normal-state information indicating that that the state of the insertion unit 22 corresponding to the receipt information of the post unit 2 is in a correct state. In this case, it is recognized that the user U has successfully received the package B placed on the tray 24 in the insertion unit 22 of the post unit 2 and based on the receipt information from the terminal 4, the information update unit 52 updates the post state information as the normal-state information. In this case, the instruction unit 53 instructs the delivery robot 3 to collect only the tray 24, for example, based on the post state information updated as the normal-state information.

Here, for example, it can be assumed that the user U has not received the package B placed on the tray 24 of the insertion unit 22 of the post unit 2, but has mistakenly operated the terminal 4 and transmitted receipt information.

On the other hand, in the case where it is determined by the information update unit 52 that there is the package B on the tray 24 of the insertion unit 22 based on the information on the object placed on the tray detected by the detection sensor 31 of the delivery robot 3, the detection being performed as an associated motion when the delivery robot 3 moves to the insertion unit 22 of the post unit 2 in performing delivery, the post state information is updated by changing the indication of the state of the insertion unit 22 from the normal state to the abnormal state, indicating that the state of the insertion unit 22 is incorrect.

In this case, the instruction unit 53 may instruct the delivery robot 3 not to collect the tray 24, for example, based on post state information updated as abnormal-state information.

In this way, the information update unit 52 updates post state information to the information indicating the normal state based on the receipt information from the terminal 4. However, in the case where the information update unit 52 determines, based on the information on the object placed on the tray detected by the detection sensor 31 of the delivery robot 3, that the package B is actually on the tray 24 of the insertion unit 22 and the package B has not been received, the post state information is updated by changing the indication of the state of the insertion unit 22 from the normal state to the abnormal state, indicating that the state of the insertion unit 22 is incorrect. Thus, the post state information indicating the internal state of the post unit 2 can be appropriately updated using the associated motion of the delivery robot 3 in performing delivery.

It should be noted that the information update unit 52 may transmit the notification informing of abnormal state of the insertion unit 22 to the terminal 4 of user U. Thus, the user U can realize that he/she has misunderstood that the package B placed on the tray 24 of the insertion unit 22 of the post unit 2 has been received, even though it has not been received.

In response to the placement information transmitted from the terminal 4, the information update unit 52 updates the post state information as the normal-state information indicating that the insertion unit 22 corresponding to the placement information of the post unit 2 is correct in this state. In this case, the information update unit 52 updates the post state information as the normal-state information, assuming that user U has placed a predetermined package B on the tray 24 of the insertion unit 22 of the post unit 2 based on the placement information from the terminal 4.

In this case, based on the post state information (the reservation information) updated as the normal-state information, the instruction unit 53 may instruct the delivery robot 3 to, for example, collect the tray 24 on which the package B is placed by taking it out from the insertion unit 22 of the post unit 2 and deliver it to a predetermined place.

Here, for example, it can be assumed that the user U has not placed the package B on the tray 24 of the insertion unit 22 of the post unit 2, or has placed a package B which is not the predetermined package B, but mistakenly operated the terminal 4 and transmitted the placement information.

On the other hand, in the case where it is determined by the information update unit 52 that there is no predetermined package B on the tray 24 of the insertion unit 22 based on the information on the object placed on the tray detected by the detection sensor 31 of the delivery robot 3, the detection being performed as an associated motion when the delivery robot 3 moves to the insertion unit 22 of the post unit 2 in performing delivery, the post information is updated by changing the indication of the state of the insertion unit from the normal state to the abnormal state, indicating that the state of the insertion unit 22 is incorrect.

In this case, the instruction unit 53 may instruct, for example, not to collect the tray 24 on which the package B is placed from the insertion unit 22 of the post unit 2 based on the post state information updated as abnormal-state information.

Thus, the information update unit 52 updates the post state information as the normal-state information based on the placement information from the terminal 4. However, in the case where the information update unit 52 determines that the predetermined package B is not actually placed on the tray 24 of the insertion unit 22 based on the information on the object placed on the tray detected by the detection sensor 31 of the delivery robot 3, the post state information is updated by changing the indication of the state of the insertion unit 22 from the normal state to the abnormal state, indicating that the state of the insertion unit 22 is incorrect and an unknown object has been placed on the tray. Thus, the post state information indicating the internal state of the post unit 2 can be appropriately updated using the associated motion of the delivery robot 3 in performing delivery.

It should be noted that the information update unit 52 may transmit a notification to the terminal 4 of the user U notifying that insertion unit 22 is in the abnormal state. Thus, the user U can recognize that he/she has mistakenly believed that the predetermined package B has been placed on the tray 24 of the insertion unit 22 of the post unit 2, even though it has not been placed.

As described above, in the delivery management system 1 according to this embodiment, the information update unit 52 more accurately updates the post state information in the storage unit 51 based on the information of the tray 24 of the insertion unit 22 detected by the NFC sensor 23 of the post unit 2, the information on the object placed on the tray detected by the detection sensor 31 of the delivery robot 3, and the receipt information and the placement information transmitted from the terminal 4. Then, the instruction unit 53 gives an instruction to the delivery robot 3 based on the accurately updated post state information.

Here, in the case where the delivery robot 3 performs delivery or collection with respect to the post unit 2, the information on the object placed on the tray is detected using the detection sensor 31 of the delivery robot 3. The information update unit 52 more accurately updates the post state information in the storage unit 51 based on the information on the object placed on the tray detected by the detection sensor 31 of the delivery robot 3.

Therefore, by appropriately updating the post state information indicating the internal state of the post unit 2 utilizing the associated motion of the delivery robot 3 in performing delivery and collection of packages, the delivery robot 3 can perform delivery more efficiently thereby the shipping cost can be reduced.

### Second Embodiment

In this embodiment, when the delivery robot 3 delivers the tray 24 on which the package B is placed to the insertion unit 22 in the post unit 2 or collects the tray 24 on which the package B is placed from the insertion unit 22, the detection sensor 31 of the delivery robot 3 may detect the object in another insertion unit 22 of the post unit 2. At this time, the information update unit 52 may update the post state information in the storage unit 51 based on the information on the object placed on the tray detected by the detection sensor 31. Thus, the post state information indicating the internal state of the post unit 2 can be appropriately updated using the associated motion of the delivery robot 3 in performing delivery.

When the delivery robot 3 delivers the tray 24 on which the package B is placed to the insertion unit 22 of the post unit 2 or collects the tray 24 on which the package B is placed from the insertion unit 22, the detection sensor 31 of the delivery robot 3 may detect an object in the insertion unit 22 of another post unit 2 installed on a traveling route to the target post unit 2. At this time, the information update unit 52 may update the post state information in the storage unit 51 based on the information on the object placed on the tray detected by the detection sensor 31 of the delivery robot 3. Thus, the post state information indicating the internal state of the post unit 2 can be appropriately updated using the associated motion of the delivery robot 3 in performing delivery.

Furthermore, a plurality of the delivery robots 3 may perform delivery and collection with respect to the respective insertion units 22 of the same post unit 2, and the detection sensors 31 of the respective delivery robots 3 may respectively detect an object in the respective insertion units 22 of the same post unit 2. The information update unit 52 may compare the information on the objects placed on the trays detected by the respective detection sensors 31 and update the post state information in the storage unit 51. Thus, the post state information indicating the internal state of the post unit 2 can be more accurately updated using the associated motion of the plurality of the delivery robots 3 in performing delivery.

At this time, the information update unit 52 may take a majority vote based on the information on the object placed on the tray detected by each detection sensor 31, and may regard the detection sensor 31 of the delivery robot 3 which outputs a different result as abnormal. For example, the detection sensor 31 regarded as being abnormal can be quickly replaced with a normal detection sensor 31.

Furthermore, in the case where the detection result of the detection sensor 31 of the delivery robot 3 is different from the detection result of the NFC sensor 23 of the insertion unit 22 of the post unit 2, the information update unit 52 may regard the detection sensor 31 of the delivery robot 3 as abnormal. This is because the reliability of the NFC sensor 23 of the insertion unit 22 is higher than that of the detection sensor 31 of the delivery robot 3.

Furthermore, in the package B, a reception deadline by which the user U receives the package B may be set in advance. The package B may be, for example, frozen or refrigerated. After delivering the package B to the insertion unit 22 of the post unit 2, the delivery robot 3 may move to the post unit 2 within a predetermined time after the reception deadline. At this time, the detection sensor 31 of the delivery robot 3 detects an object in the insertion unit 22 of the post unit 2.

In the case where the delivery robot 3 determines that the package B with the reception deadline set has not been received based on the information on the object placed on the tray in the insertion unit 22 detected by the detection sensor 31, it may collect the package B. In the case where a certain time elapses after the expiration date of the package B, the quality of the package B, that is a frozen goods or a refrigerated goods, may deteriorate. Therefore, in the case where the delivery robot 3 determines that a package B for which the expiration date is set has not been received, it collects the package B.

In the case where the detection sensor 31 of the delivery robot 3 detects one object in the post unit 2 and the NFC sensor 23 of the post unit 2 detects that the tray 24 is inserted in the area where the one object has been detected, the information update unit 52 may update the post state information so that the post state information indicates that there are two objects in the post unit 2 with the detected tray 24 as a boundary the two objects. This is because the tray 24 cannot be inserted in the area where there is an object.

Although some embodiments of the present disclosure have been described, these embodiments are presented as examples and are not intended to limit the scope of the disclosure. These new embodiments can be implemented in various other forms, and various omissions, substitutions, and changes can be made without departing from the gist of the disclosure. These embodiments and variations thereof are included in the scope and gist of the disclosure, as well as in the claims and their equivalents.

The present disclosure can also be realized by having processor execute a computer program for each of the processes performed by the delivery management system 1 described above.

The program may be stored and supplied to the computer using various types of non-transitory computer readable media. Non-transitory computer readable media include various types of tangible storage media. Examples of non-transitory computer readable media include magnetic recording media (For example, flexible disk, magnetic tape, hard disk drive), magneto-optical recording media (e.g., magneto-optical disk), CD-ROM (Read Only Memory), CD-R, CD-R/W, and semiconductor memory (For example, mask ROM, programmable ROM (PROM), erasable PROM (EPROM), flash ROM, random access memory (RAM)).

The program may be supplied to the computer by various types of transitory computer readable media. Examples of transitory computer readable media include electrical signals, optical signals, and electromagnetic waves. Temporary computer readable media may supply the program to the computer via wired or wireless communication channels, such as wires and optical fibers.

Each part of the delivery management system 1 according to the present embodiment can be implemented not only by a program but also partially or entirely by dedicated hardware such as an ASIC (Application Specific Integrated Circuit) or FPGA (Field-Programmable Gate Array).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A delivery management system, comprising:
a post unit in which a package is placed on a tray to which the package is associated in advance, the package and the tray being insertion-arrangeable in respective insertion units of the post unit, and the respective insertion units are provided with a sensor for detecting information on the tray inserted into the respective insertion units;
a delivery robot configured to deliver the tray on which the package is placed to an insertion unit of the post unit or collect the tray on which the package is placed from the insertion unit and detect an object on the tray inserted into the insertion unit of the post;
a terminal for transmitting receipt information indicating that a user has received the package placed on the tray located in the insertion unit of the post unit, and placement information indicating that the user has placed the package on the tray located in the insertion unit of the post unit;
a storage unit configured to store post state information indicating the state of the insertion unit of the post unit;
an information update unit configured to update the post state information in the storage unit based on information on the tray in the insertion unit detected by the sensor of the information update unit, information on the object placed on the tray detected by the sensor of the delivery robot, and the receipt information and the placement information transmitted from the terminal; and
an instruction unit configured to instruct the delivery robot to deliver the tray on which the package is placed and to collect the tray on which the package is placed, based on the post state information updated by the information update unit.

2. The delivery management system according to claim 1, wherein
the information update unit is configured to update, in response to the receipt information transmitted from the terminal, the indication of the post state information to a normal state indicating that the insertion unit corresponding to the receipt information of the post unit is in a normal state, and
in the case where it is determined by the information update unit that there is a package on the tray in the insertion unit based on the information on the object placed on the tray detected by the sensor of the delivery robot, the detection being performed when the delivery robot has moved to the insertion unit of the post unit, the information update unit updates the post state information by changing the indication of the state of the insertion unit from the normal state to an abnormal state, indicating that the state of the insertion unit is in an abnormal state.

3. The delivery management system according to claim 1, wherein,
the information update unit is configured to update, in response to the placement information transmitted from the terminal, the post state information as normal-state information indicating that the state of the insertion unit corresponding to the placement information of the post unit is in a normal state, and
in the case where it is determined by the information update unit that there is no predetermined package on the tray in the insertion unit based on the information on the object placed on the tray detected by the sensor of the delivery robot, the detection being performed when the delivery robot has moved to the insertion unit of the post unit, the post state information is updated by changing the indication of the state of insertion unit from the normal state to the abnormal state, indicating that that state of the insertion unit is abnormal.

4. The delivery management system according to claim 1, wherein
when the delivery robot delivers the tray on which the package is placed to the insertion unit of the post unit or when the delivery robot collects the tray on which the package is placed from the insertion unit, the sensor of the delivery robot detects an object in another insertion unit of the post unit, and
the information update unit is configured to update the post state information in the storage unit based on the information on the object placed on the tray detected by the sensor.

5. The delivery management system according to claim 1, wherein,
the sensor of the delivery robot detects, when the delivery robot delivers the tray on which the package is placed to the insertion unit of the post unit or collects the tray on which the package is placed from the insertion unit, an object in an insertion unit of another post unit installed on a traveling route to the post unit, and
the information update unit updates the post state information in the storage unit based on the information on the object placed on the tray detected by the sensor of the delivery robot.
